(19) United States
(12) Patent Application Publication
(10) Pub. No.: US 2003/0014374 A1
(43) Pub. Date: Jan. 16, 2003

(54) Device for braking and stopping a drum in a wipping material dispensing apparatus

(76) Inventor: Sylvain Lambert, Neuilly Sur Marne (FR)

Correspondence Address: James E Nilles, Nilles & Nilles, Firstar Center Suite 2000, 777 East Wisconsin Avenue, Milwaukee, WI, 53202-5345, US

(21) Appl. No.: 10/018,318

(22) PCT Filed: Apr. 4, 2001
(86) PCT No.: PCT/FR00/01002

(30) Foreign Application Priority Data
Mar. 30, 1999 (FR) 99/05739

(51) Int. Cl. G06F 17/00; G07B 17/02

(52) U.S. Cl. 705/401

(57) ABSTRACT

This list system for managing the return of information concerning the distribution of items sent by mail or parcel post to their addressee in exchange for proof of distribution includes distribution lists for distributing agents, said lists being formed of a single sheet (1) whose front side comprises for allocation to an item an area (10) subdivided into compartments, one counterfoil (11) remaining on said sheet and for receiving via printing the information concerning said item in a code form, and one compartment (12) so as either to remain on the document as proof of distribution or be detached from it so as to form a non-delivery notice label, and withdrawal note cards which are customized by affixing said non-delivery notice label.

The present invention concerns the processing of information relating to the distribution of postal or parcel post items. It is applicable to all cases when a signature is required from the addressee so as to constitute proof of distribution and in particular to registered dispatches with and without acknowledgement.

The return of information concerning distribution by computer means is a dominant trend concerning the transport market. The invention has been embodied to fall within this context, that is in a system for the computer follow-up of items in which during handing in all the information useful for transport are transcribed into a bar code able to be read and recorded by portable distribution terminals held by the personnel concerned.

At the current moment, the management of the return of information concerning distribution is ensured with the aid of paper lists, such as the list to send by post a registered object including on a self-adhesive rear side three sheets constituting respectively proof of handing in, notice of non-delivery and proof of distribution, plus as an option an additional sheet concerning acknowledgement.

As currently made use of, that is basically manually, these paper lists have a certain number of drawbacks, namely in particular:

their high cost price;

their multiplicity within the context of postal applications where there is a specific list for each particular service;

the impossibility of automating their processing on the sending and return of acknowledgements;

the lack of reliability concerning the return of acknowledgements, the address often being incorrectly duplicated and unable to be exploited owing to their positioning at the bottom of the paper list, and also the light and fragile nature of said lists rendering them subject to deterioration or loss.

As the above list only represents some of these drawbacks, plus the fact that it would be necessary to design these forms in order to adapt them to said computer processing, it has been considered having said forms replaced by an entirely new product constituting a more satisfactory global response, said product being particularly designed for a computer processing concerning object follow-up and having regard to the evolution possibilities of this computer processing.

Thus, within the context of a computerised follow-up of objects, the invention consists of a new list system for managing return information concerning the distribution of objects sent by postal means or parcel post to their addressee in exchange for proof of distribution, such as the signature, said system being characterised in that it includes:

distribution lists for agents ensuring distribution, said lists being documents formed of a single sheet whose front side comprises, for allocation to an object, an area subdivided into compartments including a counterfoil intended to remain on said sheet and receive via printing the information concerning said object in the form of a code, and a detachable compartment, either to remain on the document as proof of distribution or be detached so as to form a non-delivery notice label, and

withdrawal note cards which are personalised via the affixing in a rectangular space reserved for this purpose of said non-delivery notice label.

According to another characteristic of the invention, each of said areas comprises an additional compartment for constituting a second detachable notice of receipt label, a notice of receipt card also being provided rendered personalised by affixing said second label in a rectangular space reserved for this purpose.

According to other preferential and/or advantageous characteristics of the invention:

said distribution list comprises a plurality of areas in the form of vertically juxtaposed rectangles ;

said sheet constituting the distribution list is an adhesive complex comprising a support back and a self-adhesive detachable film;

said sheet has a standard format to facilitate filing, and can comprise on one of its sides perforations to classify it.

These characteristics and advantages of the invention and others shall appear more clearly in the following description with reference to the accompanying drawings on which:

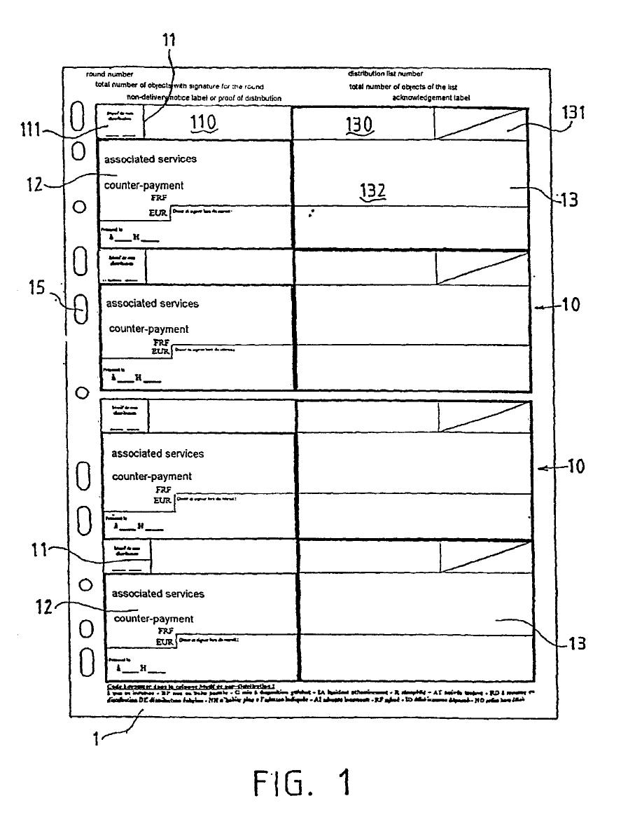

FIG. 1 is a bird's eye view of a distribution list according to the invention prior to use and provided for the sending of postal objects to be signed on delivery;

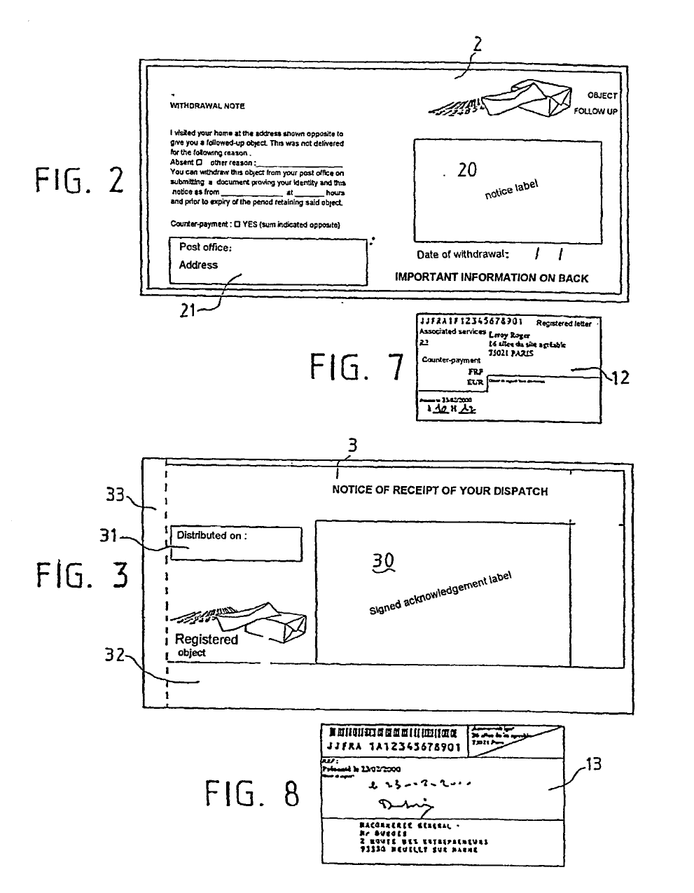

FIGS. 2 and 3 are bird's eye views respectively of a withdrawal note card and a notice of receipt card provided to be used with the distribution list of FIG. 1;

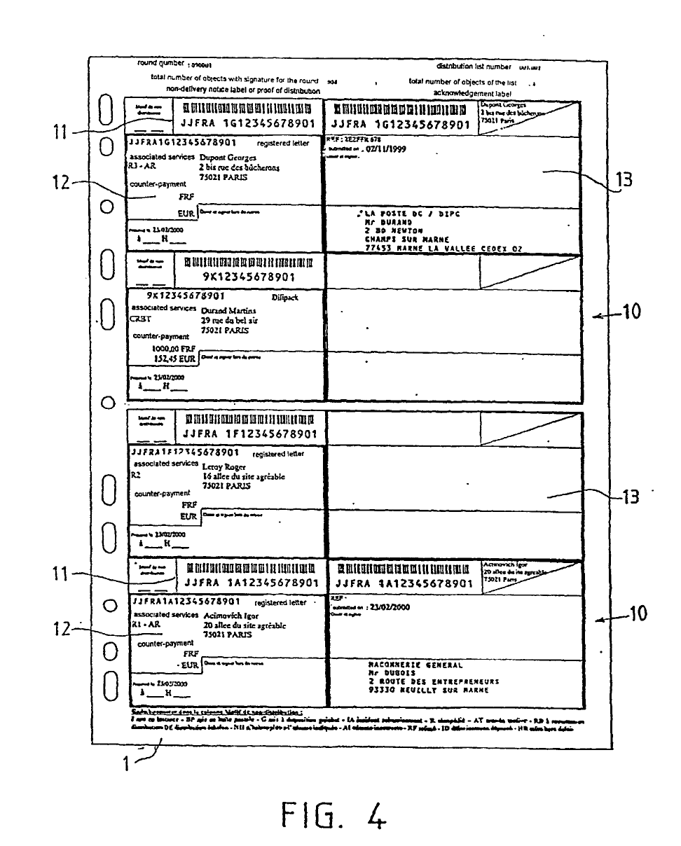

FIGS. 4, 5 and 6 are bird's eye views respectively illustrating by way of example a given list as it appears before the distributing agent goes on his round, when he returns from his round, and after processing following his round, and

FIGS. 7 and 8 are bird's eye views respectively of a non-delivery notice label and a receipt notice label which have been extracted from the list of FIGS. 4 to 6 so as to be glued respectively onto a withdrawal notice card and a receipt notice card.

The list system shown on the drawings is intended to be used as part of a computerised follow-up of registered postal dispatches which have been initially marked directly or by means of a label of a code, here a bar code, which contains their identification and all the information useful in routing them in particular conditions. In the distribution stage, the agents have a portable terminal enabling them to process the information relating to their intervention with the aid of said code present on the objects and with the list system of the present invention.

Said system comprises a distribution list shown on FIG. 1 in the form of a sheet 1, certain portions of said list being able to be detached so as to constitute labels 12 and 13 which are then used to be glued onto standard withdrawal note cards 2 and notice of receipt cards 3 for providing them with all the useful information concerning the dispatches concerned.

As shown on FIGS. 3 and 4, the cards 2 and 3 are non-personalised before receiving their label in the rectangular space reserved for them, respectively 20 and 30. The withdrawal note card 2 has on its front side a second rectangular space 21 for receiving the address and telephone number of the post office and conventional information to be completed by the distributing agent, including any reason for non-distribution and information relating to withdrawal. The front side of the notice of receipt card 3 also has here a second frame 31 for receiving the date of distribution and in addition a lower indexing rectangular space 32 for computer reshipment processing. The cards 2 and 3 advantageously have the format of letter-cards and are differentiated by virtue of their colours which in practice can be those of their homologues of current multi-part forms with reserved white spaces, said rectangular spaces 20, 21, 30-32 and other portions being intended to receive personalised information and notes. It is to be noted in addition that the notice of receipt card 3 comprises on one side a self-adhesive strip 33 able to be detached by tearing along a line of perforations.

With reference again to FIG. 1 showing the distribution list, the sheet 1 constituting it advantageously has a standard format (21 and 29.7 cm) and is formed in an adhesive complex including a support back and a self-adhesive film able to detached from the latter. In the present case, the film shall be precut as shown by the bold lines so as to selectively enable said labels 12 and 13 to be removed, whereas its other portions shall remain on the support back.

The sheet 1 is in fact a distribution list for a plurality of dispatches, namely four in the embodiment shown, and to this effect has four superimposed rectangular areas 10 each intended to be allocated to one dispatch. The upper portion of the list above the areas 10 is reserved for the distributing agent to enter useful information relating to its round, such as its identification number, its total number of objects, the number allocated to the list and the number of objects it applies to. Similarly, the lower portion of the list below the areas 10 comprises information, such as codes for the reasons for non-distribution and their significance. As a variant and so as to provide improved adaptability in relation to any possible changes, this information can only be entered during the final printing stage of the list. Secondly, the sheet 1 comprises on one side perforations 15 to enable it to be filed and classified.

Each area 10 is subdivided into three compartments; namely a compartment 11 serving as a counterfoil and intended to remain on the sheet 1, a compartment corresponding to the label 12 serving as a non-delivery notice or a distribution proof, and a compartment corresponding to the label 13 serving as a recept notice.

The counterfoil 11 is an elongated rectangle in the left hand portion of the area 10 and divided into two boxes, the larger one 110 receiving the bar code of the corresponding object and possibly the uncoded transcription of its identification number. The other box 111 comprises the printed words “Reason for non-distribution” with a space below for the distributing agent to enter the code corresponding to the reason for non-distribution. These details enable the distributing agent to carry out inspection of the return round and enter a deferred computer entry if his portable terminal were to break down.

The compartment 12 concerning a non-delivery notice or proof of distribution occupies the rest of the space of the area 10 below the box 11. It comprises the words “Associated services”, “against payment” (francs and euros), “Date and sign at the time of withdrawal” and “Submitted on”.

During printing of the list, the compartment 12 receives the following information derived from the bar code: the identification number of the object, the nature of the object, the nature of the service associated with the object, the name and address of the recipient, and the possible value of payment on delivery. In cases of anomaly concerning the code, this information can then be entered by hand. Apart from this information, the compartment 12 also receives the date of submission, the time being entered by the distributing agent.

During its round, if the compartment 12 is dated and signed by the recipient, it remains in place on the list so as to constitute a proof of distribution. It may also remain for certain reasons for non-distribution, such as an incident occurring during routing, these reasons then being shown in the associated counterfoil 11. If this is not the case, it is detached as a label to be glued unsigned onto a card 2 as shown on FIGS. 2 and 7, the card then being placed in a letter box as a withdrawal note.

The compartment 13 concerning the notice of receipt occupies the entire space of the area 10 to the right of the counterfoil 11 and the compartment 12. On the blank document, the compartment 13 has no entries, apart from the lines defining three cases 130, 131, 132. The information it contains when used is the bar code of the object and the transcription of its uncoded identification number in the case 130, the address of the recipient of the original sending with a diagonal bar in the case 131, the date of submission, a customer reference, the words “Date and sign”, and the address of the recipient of the acknowledgement in the case 132.

When it is used, the compartment 13 is unglued from the list to be used as a label to be glued onto an acknowledgement notice card 3, as shown on FIGS. 3 and 8. If it has been previously dated and signed, the card is then re-shipped. If not, the card is glued via its strip 33 onto the corresponding object which as not been distributed.

The compartments 12 and 13 are secondly advantageously differentiated by a colour with preferably white spaces being reserved for receiving information entered by the distributing agent and the recipient.

FIGS. 4 to 6 show an example of use of the distribution list of FIG. 1. On FIG. 4, it appears as it comes out after printing subsequent to a data entry with the aid of a portable terminal of the codes of all the dispatches belonging to a given round. It corresponds to a followed up object known as a “dilipack” in the second position, and three registered objects, two of which at the first and fourth positions with acknowledgement, the compartment 13 thus remaining free of print for the second and third positions.

Of course during its trip, in addition to the details he enters on the list, the distributing agent records in real time on his portable terminal the distribution of the objects or their non-distribution specifying the reasons.

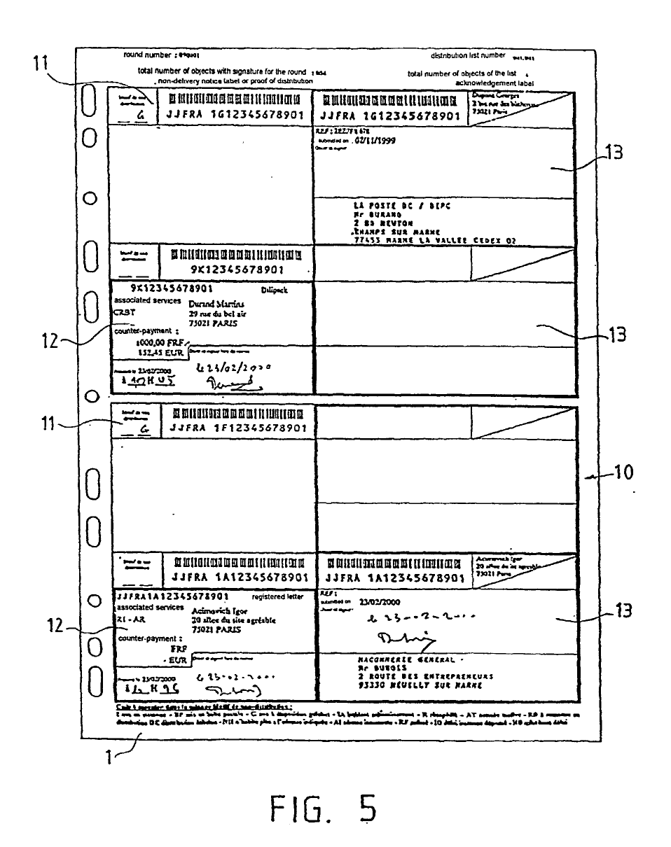

The same list when it comes back, FIG. 5, has its non-delivery notice labels 12 missing for the first and third objects, thus indicating that they have been glued onto a card 2 so as to constitute a withdrawal note and that the objects have not been distributed. The other two objects have been distributed and the proof of distribution compartment normally comprises the dated signature of the recipient, the same applying to the compartment 13 for the fourth object.

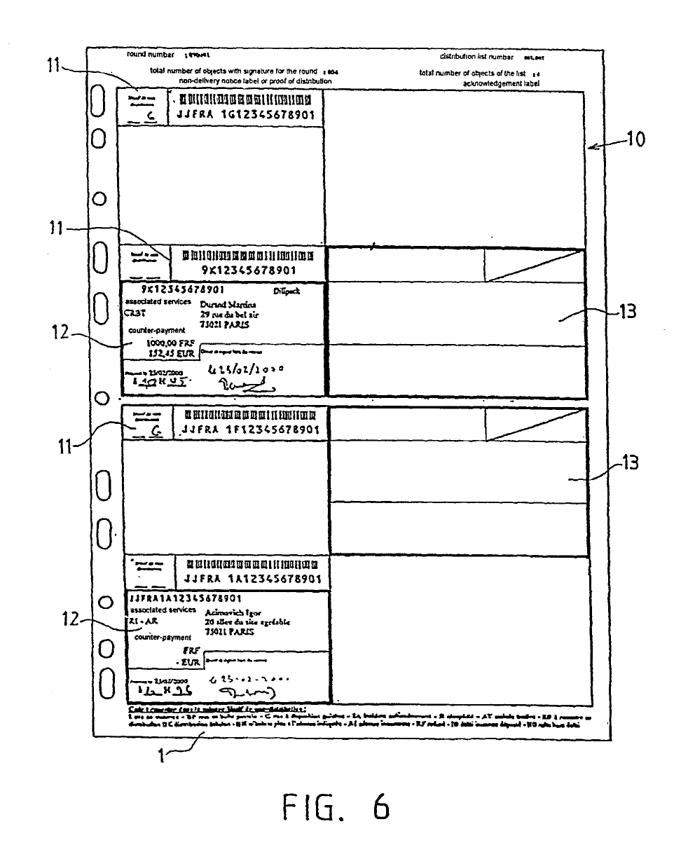

Finally, FIG. 6 shows the distribution list ready to be filed after which the notice of receipt labels 13 for the first and fourth objects have been removed to be glued onto notice of receipt cards 3, one of the latter then being glued onto the first object which remains undistributed, whereas the other corresponding to the fourth object is re-expedited.

On return, the distributing agent could therefore verify using his portable terminal the state of his distribution according to the objects remaining and any notes entered on the distribution lists which shall then be sent to a data entry and filing centre in a data base where they shall be completed with the deferred returns of information relating to the issued withdrawal notes. Said data base shall allow for considerably reduced search times compared with current search times and, because of the entering and storing of images of the list and withdrawal notes, it shall also allow restoration of document proving distribution proof signed in electronic form.

Apart from these advantages and those already mentioned, as well as a clearly increased follow-up reliability, it would now seem that the invention is clearly appropriate for the objectives referred to by providing among other things: a clear consumable reduction (especially when a distribution list would replace twelve bundle sheets) and thus a clear reduction of material costs to be also added to a reduction of the costs of preparation ; increased possibilities for the current mechanisation of the routing of objects and acknowledgements improvements in the work of distribution, such as the computerised organisation of the list according to the order of the round, harmonisation of the procedures since the same list shall be common to an extremely wide range of standard objects, and a significant reduction of weight, as well a high flexibility of evolution, so as to satisfy new needs and requirements.

1. List system intended as part of a computerised object follow-up for managing return information concerning the distribution of postal objects or objects sent by parcel post to their recipient in exchange for a proof of distribution, such as the signature, said system being characterised in that it includes
distribution lists for agents ensuring distribution, said lists being documents formed of a single sheet (1) whose front side comprises, for allocation to an object, an area (10) subdivided into compartments, including a counterfoil (11) intended to remain on said sheet and for receiving via printing the information concerning said object in a code form, and a compartment (12) able to be detached, either to remain on the document as proof of distribution or be detached so as to form a non-delivery notice label, and
withdrawal note cards (2) which are personalised by affixing to them, in a frame (20) reserved for this purpose, said non-delivery notice label (12).

2. List system according to claim 1, characterised in that each of said areas (10) comprises an additional compartment (13) for constituting a second detachable notice of receipt label, a notice of receipt card (3) also being provided and personalised by affixing said second label in a frame (30) reserved for this purpose.

3. List system according to claim 1 or 2, characterised in that said distribution list (1) comprises a plurality of areas (10) in the form of vertically juxtaposed rectangles.

4. List system according to one of claims 1 to 3, characterised in that said sheet (1) constituting the distribution list is an adhesive complex comprising a support back and a detachable self-adhesive film.

5. List system according to one of claims 1 to 4, characterised in that said sheet (1) has a standard format so as to facilitate its filing.

6. List system according to one of claims 1 to 5, characterised in that said sheet (1) comprises on one of its sides perforations (15) enabling it to be classified.
